(19) United States
(12) Patent Application Publication
(10) Pub. No.: US 2005/0193900 A1
(43) Pub. Date: Sep. 8, 2005

(54) Device and method for separation of cheese and whey during cheese manufacture

(75) Inventor: Michael E. Rosa, Tulare, CA (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Land O'Lakes, Inc., Arden Hills, MN (US)

(21) Appl. No.: 10/795,625

(22) Filed: Mar. 8, 2004

(51) Int. Cl. A23C 1/00

(52) U.S. Cl. 99/452

(57) ABSTRACT

An in-line static separator for separating whey from curd having a screen with an inlet end and a outlet end and a substantially uninterrupted perimeter defining a flow cavity. The in-line separator includes a flow directing element fixedly positioned within the flow cavity. The flow directing element forces the curd and whey toward the perimeter of the screen such that the whey passes through the screen while the curd flows through the flow cavity and exits the screen through the outlet end thereby separating whey from curd.

### BACKGROUND OF THE INVENTION

The present invention relates to a device for separating whey from curd in a cheese making process. More particularly, the present invention relates to an in-line static device for separating whey from curd in the cheese making process.

The manufacture of cheese is generally performed in a batch process where milk is typically pasteurized and coagulated in a number of ways to form a cheese curd. One way to form a curd is to lower the pH of the milk by adding acid or a culture to reduce the pH to the isoelectric point where curd forms. A second method of forming a curd is the addition of a coagulating enzyme such as rennet. During the formation of the curd, a significant quantity of whey is generated with the curd.

To separate the whey from the curd, the curd is typically cut while residing within the cheese making vessel in which the curd is formed. After the curd is cut, a slurry of curd and whey is processed over a slotted conveyor or similar apparatus to separate the whey from the curd by draining the whey from the curd. Utilizing a slotted conveyor belt allows the whey to pass through the slots while retaining the curd on the belt.

Alternatively, a whey pre-draw step may be preferred. In a whey pre-draw step, some or all of the whey is removed from the mixture of curds and whey in the cheese making vessel before the curd is cut and sent to a slotted conveyer or similar apparatus to separate the remaining whey from the curd. In this case, the curd can be formed in a vessel having agitation such that the curd does not form into a large agglomeration. Agitation of the vat allows the curd to remain suspended in a whey-curd slurry. In the usual practice, a whey pre-draw step is carried out by removing whey by pumping it from a port in the side of the cheese making vessel, but suspended curd particles may easily be incorporated into the whey pre-draw stream with resulting losses in cheese yields and difficulties in further whey processing. To prevent incorporation of curd particles in the pre-draw whey stream it has been necessary to stop vat agitation to allow curd to settle before the whey pre-draw can be carried out. Without agitation the curd settles to the bottom before the whey pre-draw step and forms a large mat that is difficult to break apart. As the curd is settling, the metabolic activity of starter bacteria used in cheese making continues to convert milk lactose into lactic acid and galactose. The lactic acid and galactose compounds present problems in further whey processing. Lactic acid lowers the pH of the whey stream rendering the whey stream more difficult to dry. Galactose is very detrimental to the whey drying process as it will not crystallize from the whey and imparts undesirable hygroscopic character to the dried whey, which reduces the shelf-life of dried whey. Once the whey pre-draw step is complete, the agitator must be started to re-cut the curd mat so that final separation of whey from curd can be carried out. However the agitator is subjected to a large amount of torque and stress which can cause equipment failure resulting in a delay in production.

### SUMMARY OF THE INVENTION

The present invention includes an in-line static separator for separating whey from curd in a whey pre-draw step without stopping agitation of the curd and whey slurry in the vat. The separator includes a screen having an inlet end and an outlet end and a substantially uninterrupted perimeter defining a flow cavity. A flow-directing element fixedly positioned within the flow cavity forces the whey pre-draw stream containing curd and whey towards the perimeter of the screen. With the curd and whey forced towards the perimeter of the screen, the whey passes through the screen and is directed to further processing while the curd flows through the flow cavity and exits the static separator through the outlet end and returns to the cheesemaking vat, thereby separating the whey from the curd.

### BRIEF DESCRIPTION OF THE DRAWINGS

FIG. 1 is a schematic view of a cheese making process including the in-line static separator of the present invention.

FIG. 2 is a cutaway view of the in-line static separator of the present invention illustrating a flow-directing element of the present invention within a filter screen.

### DETAILED DESCRIPTION OF THE PREFERRED EMBODIMENTS

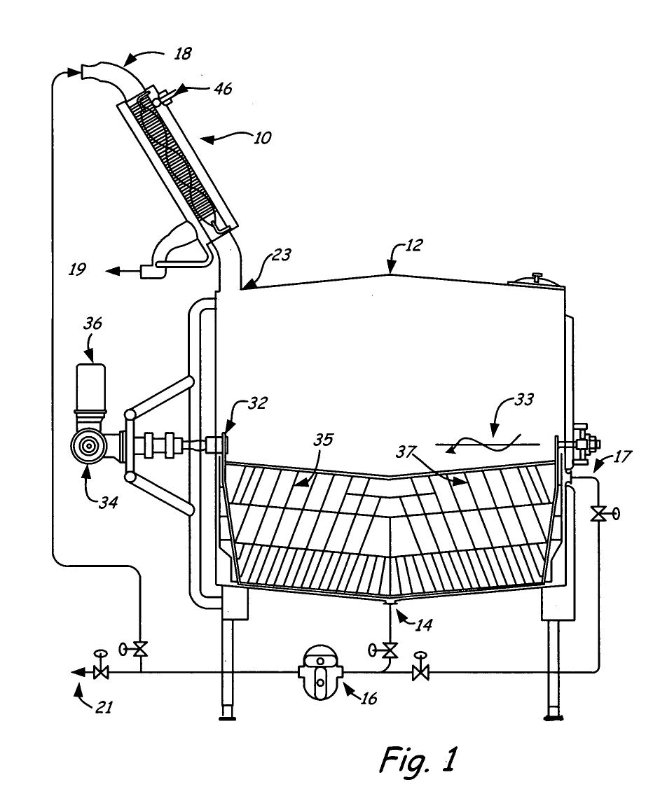

An in-line static separator of the present invention is generally illustrated in FIG. 1 at 10. The in-line static separator 10 is preferably positioned above a curd forming vessel 12.

The curd is formed in the curd forming vessel 12 under agitation by rotating an agitator 32 powered by a motor 36 where the motor 36 is coupled to the agitator with a gear box 34. Agitation during the curd forming process forms smaller curds, in contrast to one large mass, that are in a slurry with the whey. When the curd forming process is complete, agitation is continued while a whey pre-draw step is executed by directing the slurry through ports 14 or 17 via a pump 16, preferably a positive displacement pump, which pumps the slurry of curd and whey through the in-line static separator 10 to separate whey from the curd. The curd is recycled back into the curd forming vessel 12 and the separated whey is directed to conventional whey processing 19.

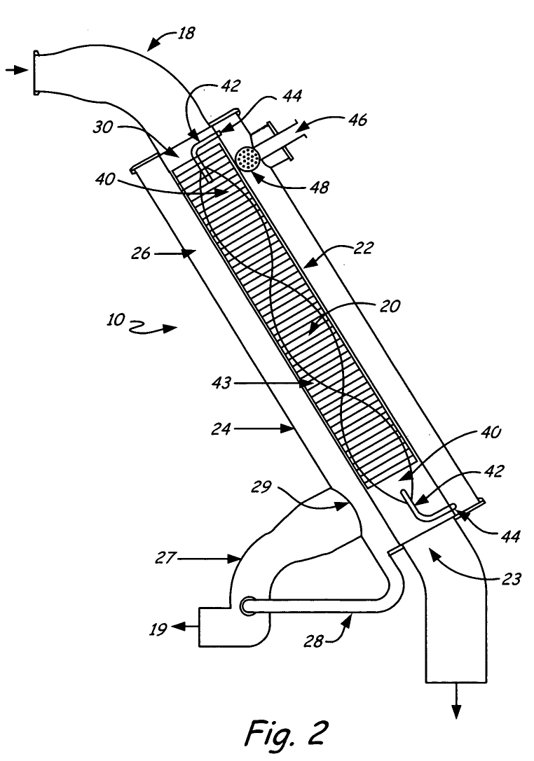

Referring to FIGS. 1 and 2, the whey and curd slurry enter the in-line static separator 10 through an inlet port 18 and contact a flow-directing element 20 that is fixedly positioned within a flow cavity 30 defined by a filter screen 22. The flow-directing element 20 directs the slurry into contact with the filter screen 22.

The flow directing element 20 is preferably helical shaped which forces the whey and curd towards a perimeter 43 of the filter screen 22 where the whey passes through the filter screen 22 and into an annular space 26 defined between the filter screen 22 and a housing 24. The filter screen 22, the housing 24 and the flow-directing element 20 are preferably constructed from stainless steel.

The flow-directing element 20 is preferably a flat, stainless steel strip of material that is twisted to form the generally helical shape and also includes tapered ends 40. The flow directing element 20 is secured within the filter screen 22 with generally “L” shaped rods 42 that are secured to the tapered ends 40 of the flow directing element 20. Legs of the “L” shaped rods 42 are inserted through apertures 44 in the filter screen 22 and secure the flow directing element to the filter screen 22 with any of a number of fastening devices including a spring force, a frictional engagement, a weld, a threaded nut engaging a threaded portion of the generally “L” shaped rods 42 and a pin inserted through an aperture in the generally “L” shaped rods 42.

As the whey passes through the filter screen 22, the whey flows through a whey outlet port 29 and exits the housing 24. The housing 24 also includes a drain 28 that intersects a pipe 27 attached to the whey outlet port 29 where the drain 28 allows any remaining whey to be removed from the housing 24. The whey exiting the in-line static separator 10 is processed through conventional whey processing 19.

The concentration of the whey in the curd is reduced as the slurry is processed along a length of the filter screen 22. The curd contains less whey exiting an outlet port 23 of the filter screen 22 than entering the inlet port 18. As the curd and whey slurry exit the outlet ports 23 and 29, respectively, the curd re-enters the curd forming vessel 12 and the whey is processed through conventional whey processing 19.

The curd and whey slurry is passed through the in-line static separator 10 to remove a selected amount of whey from the curd to form a specific type of cheese. The slurry can be rapidly passed through the in-line static separator 10 in a pre-draw step without stopping the agitation in the cheese making vessel until all, or nearly all, of the whey is separated from the curd by the in-line static separator 10. Preferably, the slurry will be passed through the in-line static separator 10 until about 40% of the whey is separated from the curd by the in-line static mixer 10. When the selected amount of whey has been removed from the slurry of curd and whey residing in curd forming vessel 12, the slurry of curd and whey is directed to a cheese finishing process 21.

There are several process advantages in utilizing the in-line static separator 10 when separating the whey from the curd. Significantly, the whey can be separated from the curd without having to stop the agitator 32 from rotating in direction of arrow 33 within the curd forming vessel 12 where a smooth dull edge 35 of the agitator 32 engages the curd and whey slurry.

When the agitator 32 is stopped to separate the whey from the curd, the curd has a tendency to form a mat in the bottom of the curd forming vessel 12 that may have to be re-cut before processing the curd through the cheese finishing process 21. The mat is re-cut by reversing the rotation opposite arrow 33 such that knife edges 37 engage the mat to re-cut the curd.

Having to re-cut the curd causes losses in cheese production by creating fines which are lost with the whey and proceed with the whey to create difficulties in further whey processing 19. Additionally, as the knife edges 37 cut the curd, fat globules are also cut which then pass through the screen and are lost with the whey resulting in a lower butterfat content in the finished cheese and unwanted increases in butterfat content in the whey.

Additionally, having to restart the agitator 32 when the matted block of curd is formed can place significant stress upon the agitator 32 by increasing the amount of torque needed to restart rotation of the agitator 32. The increased stress and torque required to cut the matted block of curd with the agitator 32 reduces the life of the agitator 32, the agitator gear box 34 and the motor 36 driving the agitator 32. If the agitator 32 becomes disabled, the matted curd must be removed by hand resulting in production delays and a loss of cheese production.

By executing a rapid whey pre-draw step without having to stop agitation and wait for curd to settle, the amount of lactose remaining in the vat is rapidly reduced and is no longer available to the cheese making starter bacteria remaining in the curd. This has the effect of immediately stopping the pH decrease of the whey removed by pre-draw as well as limiting the total pH decrease in a given vat of cheese. Thus, the whey can be pre-drawn when the pH of the vat has decreased by the action of starter bacteria to 6.3. The pH value of whey obtained in cheese making processes without pre-draw is commonly below a pH value of about 5.7. When whey removed by pre-draw using the inventive device is mixed with whey separated from curd in the cheese finishing process, the overall pH of whey from the entire vat is raised, providing significant advantages in drying the whey stream. Additionally, because the starter bacteria split lactose into glucose and galactose but only metabolize glucose, the galactose is a by-product and thus remains in the whey. This galactose is very detrimental to the whey drying process as, unlike lactose, it will not crystallize under normal whey processing conditions. In addition, the presence of galactose imparts undesirable hygroscopic character to the dried whey, which reduces the shelf-life of dried whey. Thus, the inventive pre-draw device provides strong benefits on the whey processing side by effecting rapid lactose removal from a vat of cheese so the action of starter bacteria to convert lactose into lactic acid and galactose is arrested.

The filter screen 22 is preferably a wedge wire filter. Wedge wire has a triangular shaped cross section. An exemplary wedge wire filter is a Vee-Wire™ Internal Circumferential Wire Construction manufactured by Johnson Screens of Bakersfield, Calif. and having a gap of 0.006 inches with a tolerance of 0.002 inches. Preferably, the perimeter 43 of the filter screen 22 is substantially cylindrical. However, other configurations of the perimeter 43 are within the scope of the present invention.

Although a wedge wire filter is preferred, other filter media are within the scope of the invention and include other screens made of material besides wedge wire. However, the filter media must include the flow cavity 30 into which the flow directing element 20 is statically secured. The filter media also must be constructed to withstand the pressure created by the pump 16 and the flow of the slurry through the static in-line separator 10. The filter media must also pass the whey while retaining the curd.

Preferably, the in-line static separator 10 is mounted above the curd forming vessel 12 at an angle where the inlet port 18 is above the outlet port 23. By positioning the static in-line separator 10 at the angle, the filtration performance of the in-line static separator 10 is enhanced because gravity assists in flow of the curd being returned to the curd forming vessel 12. Additionally, by using gravity to enhance the flow of the curd through the in-line static separator 10, damage to the curd is reduced by reducing the pressure required to process the slurry. While positioning the in-line static separator 10 at an angle is preferred, a horizontally positioned or vertically positioned in-line static separator are within the scope of the present invention along with any angle therebetween.

Normal practice in a cheese making operations requires thorough cleaning at intervals. This is usually carried out by clean-in-place procedures. In addition, over time, the filter screen 22 may have a tendency to become blinded (clogged) by curd particles. If the curd particles blind the filter screen 22, the in-line static separator 10 may be cleaned in place with a spray nozzle 48 positioned through a cleaning port 46 and into the annular space 26 between the filter screen 22 and the housing 24 near the inlet port 18. With the in-line static separator 10 isolated from the cheese making process, water and/or a cleaning solution can be discharged into the in-line static separator 10 through the spray nozzle 48 to execute clean-in-place procedures or clean the curd particles from the filter screen 22 and thereby minimize the effect of the filter screen being blinded with the curd particles.

Although the present invention has been described with reference to preferred embodiments, workers skilled in the art will recognize that changes may be made in form and detail without departing from the spirit and scope of the invention.

1. An in-line static separator for separating whey from curd, the separator comprising:
a screen having an inlet end and an outlet end and a substantially uninterrupted perimeter defining a flow cavity; and
a flow directing element fixedly positioned within the flow cavity wherein the flow directing element forces the curd and whey toward the perimeter of the screen such that the whey passes through the screen while the curd flows through the flow cavity and exits the screen through the outlet end thereby separating whey from the curd.

2. The separator of claim 1 and wherein the filter comprises a substantially cylindrical perimeter.

3. The separator of claim 1 and wherein the flow directing element comprises a generally helical-shaped element.

4. The separator of claim 3 wherein the generally helical-shaped element is positioned along a length of the screen.

5. The separator of claim 1 and further comprising a housing positioned about the screen such that the housing and the screen define an annular space therebetween such that the whey passes through the screen and is directed by the housing to an outlet port.

6. The apparatus of claim 5 and further comprising:
a port proximate the inlet end of the screen; and
a spray nozzle positioned through the port within the housing and wherein the spray nozzle injects a solution to clean the screen in place without having to remove the screen from the housing.

7. The separator of claim 1 and wherein the screen is positioned at an angle relative to a horizontal position such that the inlet end is raised relative to the outlet end to aid in the separation of the whey from the curd.

8. A method of separating whey from curd comprising:
passing a slurry of curd in whey through an in-line static separator in association with a screen such that the whey passes through the screen while the curd is retained by the screen.

9. The method of claim 8 wherein the in-line static separator includes an inlet port and an outlet port and the screen extending therebetween and a major portion of the whey passing through the screen while the curd flows through the outlet port.

10. The method of claim 9 wherein a generally helically configured flow-directing element is fixedly positioned within the filter screen to force the whey through the screen.

11. The method of claim 9 and wherein the slurry of curd in whey is withdrawn from a cheese making vessel having agitators, without stopping rotation of the agitators.

12. An in-line device for separating whey from curd, the device comprising:
a housing having an inlet port and an outlet port;
a filter media disposed within the housing such that the housing and the filter media form an annular space therebetween wherein the filter media includes a inlet port and an outlet port; and
a flow directing element disposed within the filter media wherein the flow directing element is statically positioned along a length of the filter media and wherein the whey and curd are directed by the flow directing element such that the whey passes through the filter media while the curd is retained within the filter media and wherein a concentration of whey with respect to curd is reduced exiting the outlet port.

13. The device of claim 12 wherein the filter media comprises a filter screen.

14. The device of claim 13 and wherein the filter screen has a substantially cylindrical perimeter.

15. The device of claim 13 and wherein the filter screen has a substantially cylindrical perimeter of internal circumferential wire construction.

16. The device of claim 15 wherein the wire construction is a wedgewire.

17. The device of claim 12 wherein the flow directing element comprises a helical configuration.

18. The device of claim 12 wherein the housing comprises a generally cylindrical configuration.

19. The device of claim 12 wherein the housing comprises:
a cleaning port proximate the inlet port; and
a nozzle disposed within the cleaning port such that the filter media may be cleaned without having to remove the filter media from the housing.

20. The device of claim 12 wherein the housing is positioned at an angle between a horizontal position and a vertical position such that the inlet port is above the outlet port.

21. The device of claim 12 wherein the housing comprises a whey discharge port for removing whey that passes through the filter media.
